(19) United States
(12) Patent Application Publication
(10) Pub. No.: US 2026/0266399 A1
(43) Pub. Date: Sep. 10, 2026

(54) PIPE RETRIEVAL

(71) Applicant: Baker Hughes Energy Technology UK Limited, Bristol (GB)

(72) Inventor: Fabio De Souza PIRES, Bristol (GB)

(21) Appl. No.: 19/166,633

(22) PCT Filed: Mar. 18, 2024
(86) PCT No.: PCT/EP2024/025120

§ 371 Date: Sep. 18, 2025

(30) Foreign Application Priority Data
Mar. 24, 2023 (GB) 2304358.1

(51) Int. Cl. F16L 1/16

(52) U.S. Cl. CPC F16L 1/166

(57) ABSTRACT

A method and apparatus for retrieving an underwater flexible pipe and a method for retrieving a subsea pipeline are disclosed. The apparatus for providing data during a flexible pipe retrieval process for an underwater flexible pipe comprises an annulus connection member comprising a housing connectible to a purge outlet of an end fitting of a flexible pipe and a fluid communication passageway having a first end that is connected to and is in fluid communication with the annulus connection member and a further end connected to and in fluid communication with an annulus pressure sensor in a waterproof housing.

The present invention relates to a method and apparatus for flexible pipe retrieval. In particular, but not exclusively, the present invention relates to regulating pipe retrieval speed based on an annulus pressure in flexible pipe body of a flexible pipe as it is lifted during retrieval.

Flexible pipes are widely used in the oil and gas industry in offshore applications for the transportation of oil, gas, water, or other fluids from one location to another. Flexible pipe is particularly useful in connecting sea-level supporting structures and subsea locations (which may be deep underwater, say 1000 metres or more), where the pipe may act as a riser. A flexible pipe is generally formed as an assembly of flexible pipe body and one or more end fittings. Flexible pipe body may have an internal diameter of typically up to around 0.6 metres (e.g. diameters may range from 0.05 m up to 0.6 m). Due to their location, flexible pipes are exposed to a range of challenging conditions that may have high pressures, seawater, high tensile strain, and corrosive environments. Flexible pipe body is therefore composed of several concentric polymeric, metallic, and/or composite layers. For example, pipe body may include polymer and metal layers, or polymer and composite layers, or polymer, metal and composite layers. Layers may be formed from a single piece such as an extruded tube or by helically winding one or more wires at a desired pitch or by connecting together multiple discrete hoops that are arranged concentrically side-by-side. Depending upon the layers of the flexible pipe used and the type of flexible pipe some of the pipe layers may be bonded together or remain unbonded. The polymeric layers generally provide sealing from fluid ingress and the metallic layers structural rigidity.

Some flexible pipes have been used for deep water (less than 3,300 feet (1,005.84 metres)) and ultra-deep water (greater than 3,300 feet) developments. It is the increasing demand for oil which is causing exploration to occur at greater and greater depths (for example in excess of 8202 feet (2500 metres)) where environmental factors are more extreme. For example, in such deep and ultra-deep water environments, ocean floor temperature increases the risk of production fluids cooling to a temperature that may lead to pipe blockage. In practice, flexible pipes are conventionally designed to perform at operating temperatures of −30° C. to +130° C. and pipe body are being developed for even more extreme temperatures. Increased depths also increase the pressure associated with the environment in which the flexible pipe must operate. For example, a flexible pipe may be required to operate with external pressures ranging from 0.1 MPa to 30 MPa acting on the pipe. Equally, transporting oil, gas or water may well give rise to high pressures acting on the flexible pipe from within, for example with internal pressures ranging from zero to 140 MPa from bore fluid acting on the pipe. As a result, the need for high levels of performance and environmental resilience from certain layers such as a pipe carcass or a pressure armour or a tensile armour layer of the flexible pipe body is increased. It is noted for the sake of completeness that flexible pipe may also be used for shallow water applications (for example less than around 500 metres depth) or even for shore (overland) applications.

The innermost layers of flexible pipe body often include an inner sheath which can be an extruded non-porous polymer layer that confines a bore fluid to its internal circumference, and often a carcass, a spirally wound interlocking metal structure which forms the very innermost layer. The carcass prevents the collapse of the inner liner and also protects the liner from abrasive particles. When a carcass layer is present in the flexible pipe body, the inner sheath is referred to as a barrier layer. When a carcass layer is not present in the flexible pipe body, the inner sheath is referred to as a liner.

The outermost layer of a flexible pipe is the outer sheath, an extruded non-porous polymer layer that protects the pipe's structural elements from the environment around the flexible pipe and prevents the ingress of seawater.

For some flexible pipes that include intermediate polymer layers flexible pipe body may include multiple annuli. For many flexible pipes though only an outer and an inner polymer layer is included. An annulus of such a flexible pipe is a region between the innermost fluid containing layer and the outermost fluid containing layer. The innermost layers in the annulus region are pressure armour layers, which are made of helically wound flattened metallic wires arranged at a lay angle close to 90°. Neighbouring wound wires in the pressure armour layer interlock to control the gap between windings. Pressure armour is designed to withstand hoop stress in the pipe wall, which is caused by the bore fluid pressure. Pairs of tensile armour layers are also located in the annulus, and these are cross-wound radially outside the pressure armour layer. Tensile armour layers are often made of slightly flattened rectangular metallic wires arranged at a lay angle of about 30-55°. Tensile armour layers support the weight of all internal pipe layers and transfer the resulting tensile stress to the sea-level supporting structures. The annulus may also have other layers such as anti-wear and anti-birdcaging tapes, and thermally insulating layers. Carbon steel wires in the annulus are thus often a feature of flexible pipes for subsea environments.

In the end fitting, flexible pipe is typically terminated by sealing and securing ends of polymer or composite layers and securing any pressure armour windings and securing the tensile armour wires. The annulus, which extends along the flexible pipe body segment, thus extends into a region within the end fitting. In configurations where two flexible pipes are joined end-to-end to form a pipeline there is no fluid connection between the annulus in one section of flexible pipe and the annulus in the other section of flexible pipe.

The annulus of flexible pipe body is usually void of fluid other than air upon delivery, with the exception sometimes of small amounts of lubrication used during the manufacturing process. That is to say, when a flexible pipe is laid for example subsea during installation, the annulus of the flexible pipe is not intended to contain quantities of hydrocarbons or acidic species as either gas or liquid. Over time after installation, the annulus of the flexible pipe tends to fill up with fluid. This is due to gases and possibly liquids diffusing from seawater through the outer sheath into the annulus due to factors such as pressure, temperature, outer sheath material, outer sheath thickness, and the like. Sometimes hydrocarbons or acidic species as gases may likewise or alternatively diffuse from the bore fluid through the inner sheath into the annulus due to the above factors and condense and/or dissolve into existing liquid there. This can be particularly the case when bore fluids contain high proportions of certain gasses and may be particularly an issue for a flexible pipe of a pipeline geographically close to a well head.

Consequentially, the annulus of a flexible pipe that has been sat subsea for a period of time may build up annulus gases to a high pressure. Were the annulus gases allowed to increase in pressure unrestricted, the pressure of annulus gases on the inside of the outer sheath could exceed the hydrostatic pressure of seawater on the outside of the outer sheath to such a degree that the outer sheath bursts (the actual annulus over-pressure, with respect to the external hydrostatic pressure, may vary depending on the structure of the outer sheath layer of the pipe and whether there is any reinforcement over or incorporated in that layer). To mitigate this problem, a minimum of two, and typically three pressure release valves are often installed in each end fitting of flexible pipes, as prescribed by the API 17J standard for unbonded flexible pipe. Thus, when annulus fluid pressure exceeds a threshold above hydrostatic seawater pressure (typically 2-3 bar), the valve opens and “purges” to relieve the pressure in the annulus. The valve therefore acts as a purge valve and helps to prevent the outer sheath from bursting due to pressure in the annulus. The maximum flow rate of the valve, the release pressure of the valve, and the like may be chosen to limit seawater ingress to the annulus during purging.

At some point it may be necessary to retrieve flexible pipes that have been installed in a subsea environment. For example, when the flexible pipes are no longer being used; to redeploy the flexible pipe in another location; perform modifications, or the like. During the retrieval process, flexible pipe body is pulled up from its installation location and reeled into a reel on a Pipe Lay Support Vessel (PLSV) or is otherwise lifted. As discussed above, if the flexible pipes have been lying in a subsea environment for a period of time, the annulus of the flexible pipes may contain gases and/or liquids under pressure. As a flexible pipe is raised from its installation location underwater towards surface level, hydrostatic pressure on the outside of the outer sheath of the flexible pipe will decrease at roughly 1 bar (0.1 MPa) per 10 m reduction in water depth, whilst annulus gas pressure is unchanged by water depth. Therefore, as the flexible pipe body is raised, the hydrostatic pressure on the outside of the outer sheath may decrease relative to the annulus pressure on the inside of the outer sheath. As described above, when the annulus pressure exceeds a threshold above the hydrostatic pressure, valves in the end fitting of the flexible pipe will open to release excess pressure. If the flexible pipe is raised towards surface level faster than the valves can release excess pressure, the flexible pipe outer sheath may burst due to the excess annulus pressure.

Conventionally, a rate of retrieval during pipe retrieval to the PLSV is limited by the capacity of the pressure release valves in the end fitting of a flexible pipe to reduce annulus pressure. Sometimes, pipe retrieval rate may be set at a fixed safe value to give the valves time to reduce annulus pressure, if needed. At other times, a camera on a Remotely Operated Vehicle (ROV) might be used to inform when to reduce the pipe retrieval rate when valves in the end fitting are open by monitoring for bubbles. Such pipe retrieval rates are often chosen conservatively with a large margin for error, as annulus pressure, when above the threshold for purging, may vary considerably, and there may be uncertainty over how many of the pressure release valves are open and hence what volume of gas is being released, thus affecting the time required for annulus pressure to be safely reduced. As a result pipe retrieval can be an unduly slow process which increases costs and down time relative to desired speeds.

It is an aim of the present invention to at least partly mitigate one or more of the above-mentioned problems.

It is an aim of certain embodiments of the present invention to help prevent outer sheath rupture during pipe retrieval.

It is an aim of certain embodiments of the present invention to provide a method for maximising pipe retrieval speed in a safe manner.

It is an aim of certain embodiments of the present invention to provide apparatus for measuring annulus pressure in a flexible pipe.

It is an aim of certain embodiments of the present invention to provide a method for retrofitting deployed flexible pipes with pressure monitoring capabilities.

It is an aim of certain embodiments of the present invention to provide a method of maximising pipe retrieval speed of flexible pipes by wirelessly transmitting data such as annulus pressure and hydrostatic pressure from an end fitting of the flexible pipe to a Pipe Lay Support Vessel (PLSV) which can adjust the pipe retrieval speed based on said data.

According to a first aspect of the present invention, there is provided a method of retrieving an underwater flexible pipe, comprising:
urging an end region of a flexible pipe towards a floating platform at a flexible pipe retrieval velocity thereby lifting the flexible pipe through water;
as the flexible pipe is lifted, determining a relationship between an annulus pressure in an annulus region of the flexible pipe and a local water pressure proximate to at least one purge outlet on an end fitting of the flexible pipe; and
responsive to the relationship, selecting the flexible pipe retrieval velocity.

In certain embodiments, said step of selecting the retrieval velocity comprises:
repeatedly determining a maximum advisable retrieval velocity; and
   setting the flexible pipe retrieval velocity at or within 10 m/hour below the maximum advisable retrieval velocity.

In certain embodiments, the method further comprises:
selecting the flexible pipe retrieval velocity according to:

$$AP < WP + SM$$

where AP is annulus pressure proximate to the purge outlet, WP is local water pressure proximate to the purge outlet, and SM is a predetermined safety margin.

In certain embodiments, the predetermined safety margin is at least 2 bar and optionally is at least 3 bar.

In certain embodiments, the method further comprises:
as the flexible pipe is lifted, repeatedly measuring annulus pressure (AP) proximate to the purge outlet and repeatedly determining local water pressure (WP) proximate to the purge outlet; and
determining a rate of change of annulus pressure and a rate of change of water pressure responsive thereto.

In certain embodiments, the method further comprises:
securing a module, comprising a housing that contains an annulus pressure sensor and a local water pressure sensor, to the end fitting; and
securing a respective fluid communication passageway in fluid communication with the annulus pressure sensor between the housing and the purge outlet.

In certain embodiments, the method further comprises:
communicating local water pressure to the local water pressure sensor via a water pressure port in the housing and a respective further fluid communication passageway between the water pressure port and the local water pressure sensor; and
communicating annulus pressure to the annulus pressure sensor via the first fluid communication passageway.

In certain embodiments, the method further comprises:
wirelessly communicating an annulus pressure value and a local environmental water pressure value from the module.

In certain embodiments, the method further comprises:
securing a first fluid communication passageway, in fluid communication with an annulus pressure sensor on a remotely operated vehicle (ROV) that further comprises a local water pressure sensor, to the purge outlet.

In certain embodiments, the method further comprises:
wirelessly communicating by transmitting an ultrasound signal from an ultrasound modem in the module or by transmitting light from one or more light emitting elements on the housing or by wirelessly transmitting a wireless signal from an ROV proximate to the module.

According to a second aspect of the present invention, there is provided apparatus for providing data during a flexible pipe retrieval process for an underwater flexible pipe, comprising:
an annulus connection member comprising a housing connectible to a purge outlet of an end fitting of a flexible pipe; and
a fluid communication passageway having a first end that is connected to and is in fluid communication with the annulus connection member and a further end connected to and in fluid communication with an annulus pressure sensor in a waterproof housing.

In certain embodiments, the annulus connection member comprises a rigid body that has a first body end region that includes a purge valve and purge orifice and a further body end region that comprises a securing element for securing to an aperture of the purge outlet.

In certain embodiments the apparatus further comprises:
a module comprising the waterproof housing and the annular pressure sensor and further comprising a water pressure port comprising an opening in the housing and the fluid communication passageway extending between the opening and a water pressure sensor in the housing.

In certain embodiments the apparatus further comprises:
a wireless modem comprising a transmitter element for transmitting an annulus pressure value and a local water pressure value.

In certain embodiments the apparatus further comprises:
a storage medium for recording a plurality of an annulus pressure value, a local water pressure value, and a time value associated with the annulus pressure value and the local water pressure value.

In certain embodiments the apparatus further comprises:
a remotely operated vehicle (ROV) comprising the waterproof housing and the annulus pressure sensor and further comprising a water pressure port comprising a through opening in an outer wall of the ROV and a fluid communication passageway extending between the opening and a water pressure sensor in the housing of the ROV.

In certain embodiments the apparatus further comprises:
a wireless modem comprising a transmitter element for transmitting an annulus pressure value and a local water pressure value.

In certain embodiments the securing element comprises a piercing element for securing to the aperture of the purge outlet.

According to a third aspect of the present invention there is provided a method of retrieving a subsea pipeline, comprising:
one-by-one, urging an end of a flexible pipe, of each of a plurality of flexible pipes of a pipeline that comprises a plurality of flexible pipes disposed in an end-to-end configuration, towards a surface platform thereby lifting the pipeline through the water; and
varying a flexible pipe retrieval velocity responsive to an annulus pressure in an annulus region of a current uppermost flexible pipe of the pipeline as the flexible pipes of the pipeline are lifted, to maintain at least a predetermined average flexible pipe retrieval velocity for the pipeline.

In certain embodiments, the method further comprises:
varying the flexible pipe retrieval velocity also responsive to a local water pressure proximate to the current uppermost flexible pipe of the pipeline.

In certain embodiments, the method further comprises selecting the flexible pipe retrieval velocity according to:

$$AP < WP \pm SM$$

where AP is annulus pressure proximate to the purge outlet, WP is local water pressure proximate to the purge outlet, and SM is a predetermined safety margin.

In certain embodiments, a flexible pipe retrieval velocity is a constant flexible pipe retrieval velocity.

In certain embodiments, a flexible pipe retrieval velocity is a variable flexible pipe retrieval velocity.

Certain embodiments of the present invention provide a method of monitoring annulus pressure of a flexible pipe that has already been deployed to a subsea environment.

Certain embodiments of the present invention provide a method of monitoring hydrostatic pressure at a flexible pipe that has already been deployed to a subsea environment.

Certain embodiments of the present invention provide apparatus that monitors annulus pressure of a flexible pipe and hydrostatic pressure and transfers, through a wire, said data to a Pipe Lay Support Vessel (PLSV).

Certain embodiments of the present invention provide apparatus that monitors annulus pressure of a flexible pipe and wirelessly transmits said data to a Pipe Lay Support Vessel (PLSV).

Certain embodiments of the present invention provide apparatus that monitors annulus pressure of a flexible pipe and displays said data.

Certain embodiments of the present invention provide apparatus that can be integrated into a control system to regulate a pipe retrieval velocity of flexible pipes.

Certain embodiments of the present invention provide a method for optimising a flexible pipe retrieval velocity of flexible pipes by reading data related to pressure.

Certain embodiments of the present invention provide a method of using annulus pressure and local water pressure to regulate a flexible pipe retrieval velocity within safe limits such that the flexible pipe does not burst.

Embodiments of the present invention will now be described hereinafter, by way of example only, with reference to the accompanying drawings in which:

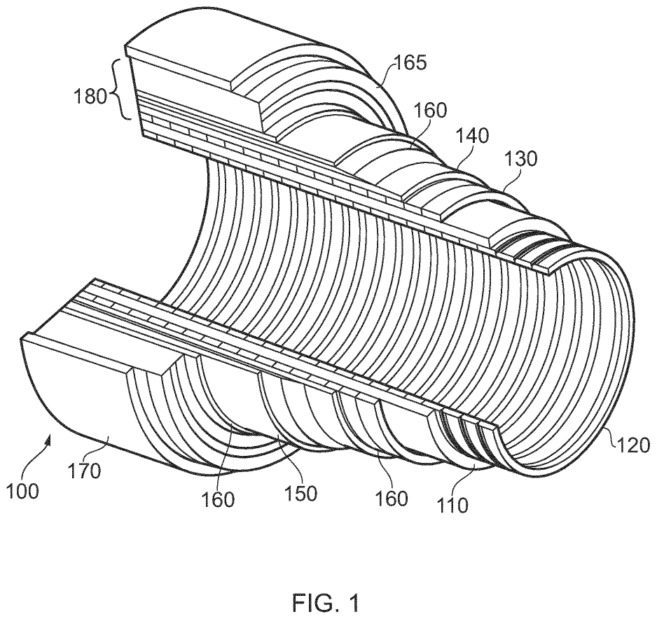

FIG. 1 illustrates flexible pipe body;

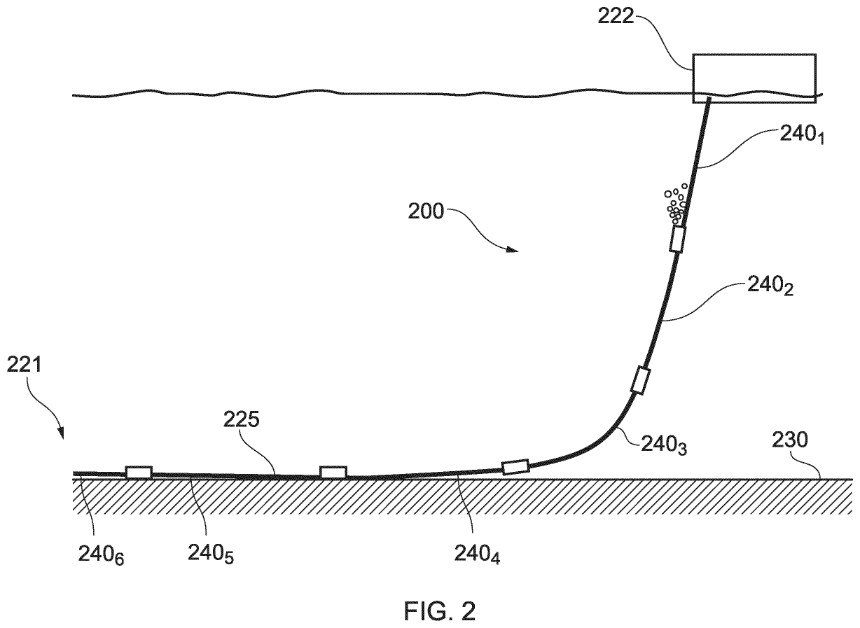

FIG. 2 illustrates certain uses of flexible pipes as a pipeline and pipe retrieval;

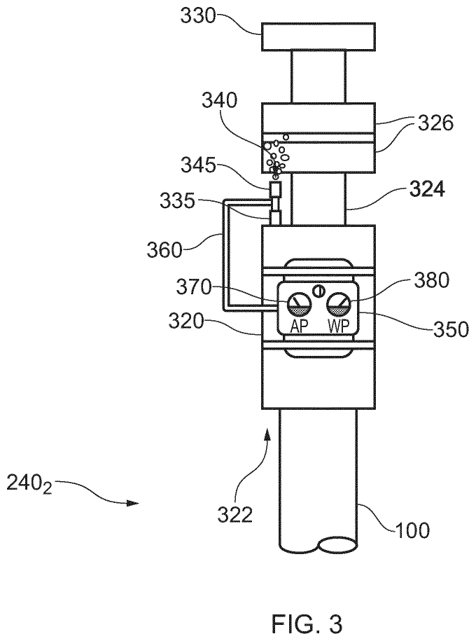

FIG. 3 illustrates a flexible pipe and an end fitting with a module attached;

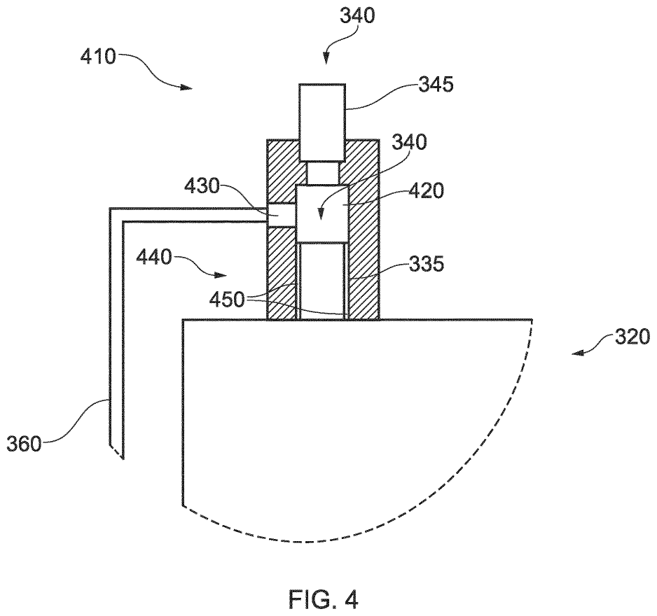

FIG. 4 illustrates another view of the end fitting in which a purge outlet and a T-connection and tubing attached are illustrated;

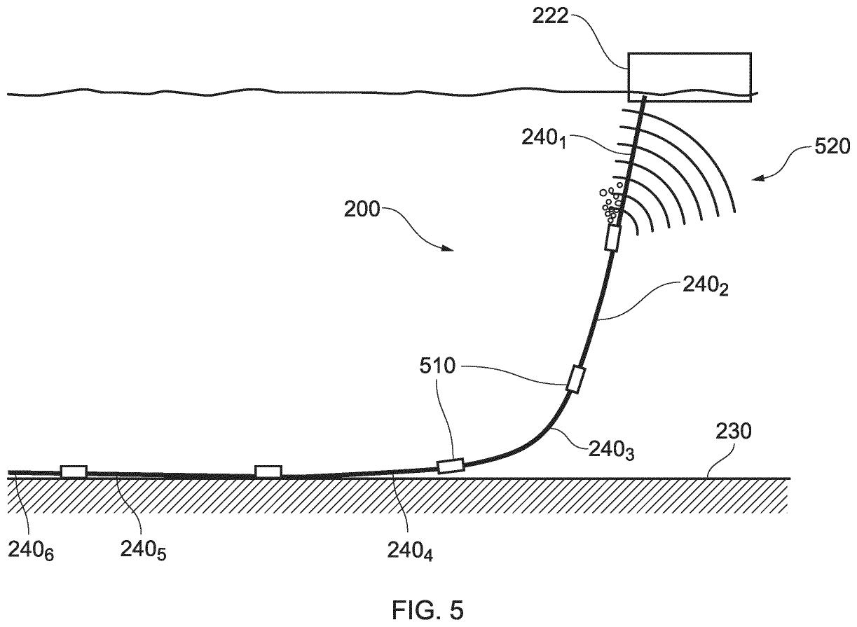

FIG. 5 illustrates a pipeline with wireless communication between an attached module and a Pipe Lay Support Vessel (PLSV);

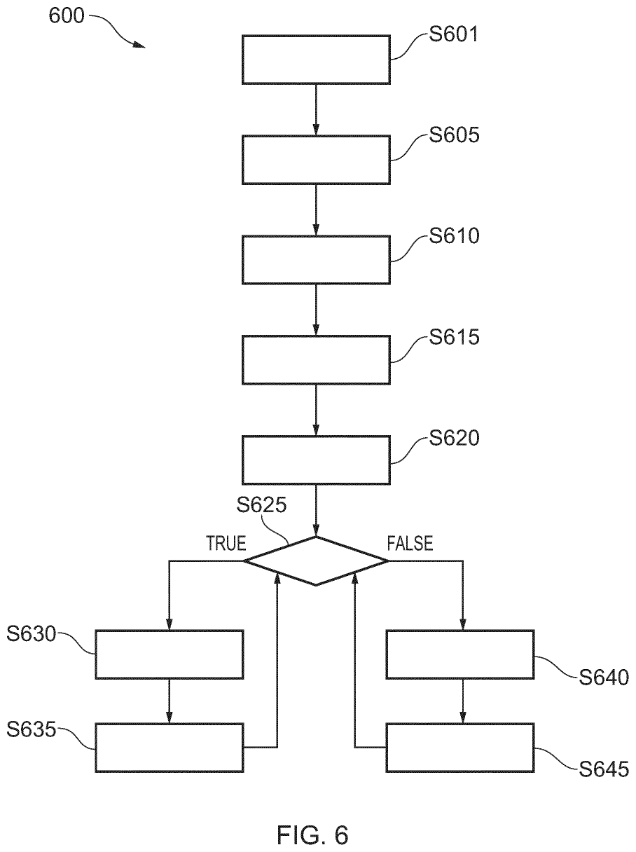

FIG. 6 illustrates a method of flexible pipe retrieval;

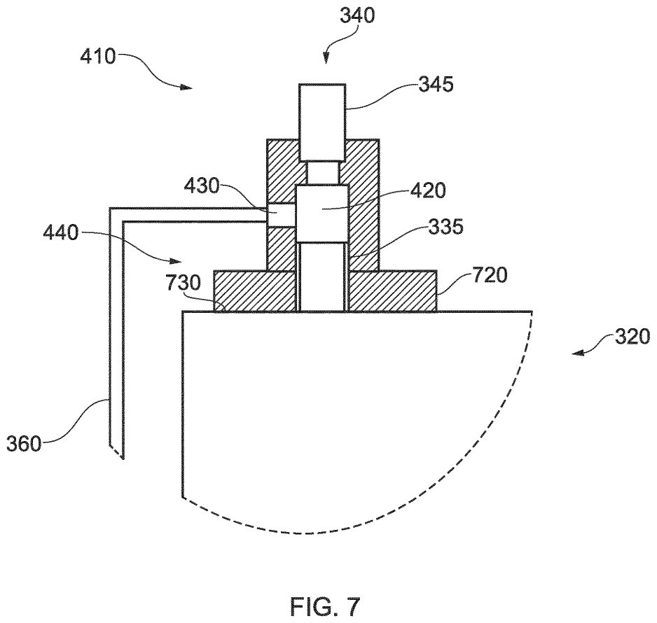

FIG. 7 illustrates an alternative of a T-connection and tubing attached to a purge outlet;

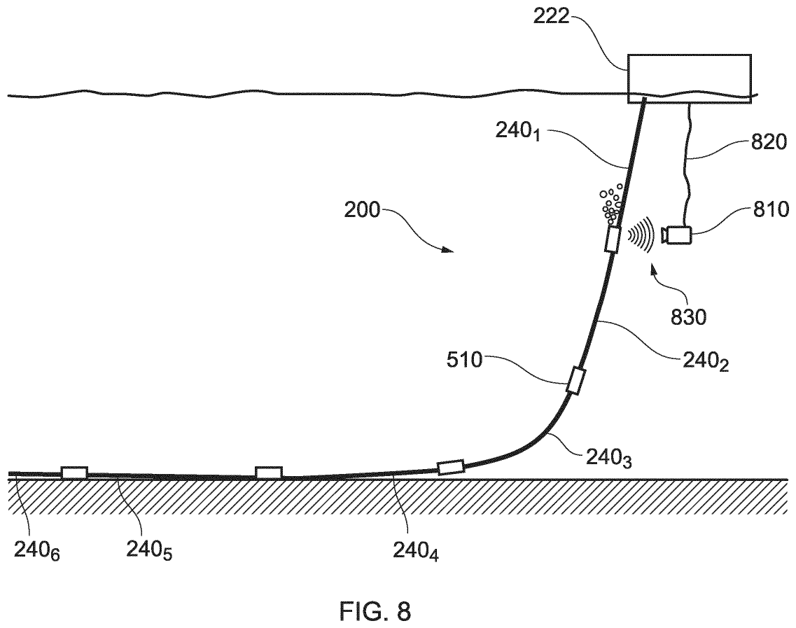

FIG. 8 illustrates an alternative of the pipeline with communication between the module and an ROV, itself in wired communication with the PLSV;

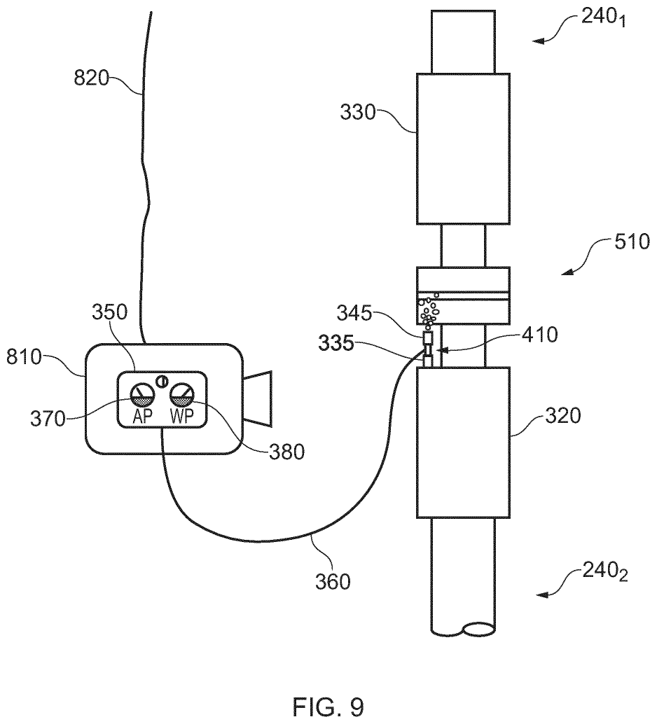

FIG. 9 illustrates an alternative of the pipeline with communication between the module, ROV, and the PLSV;

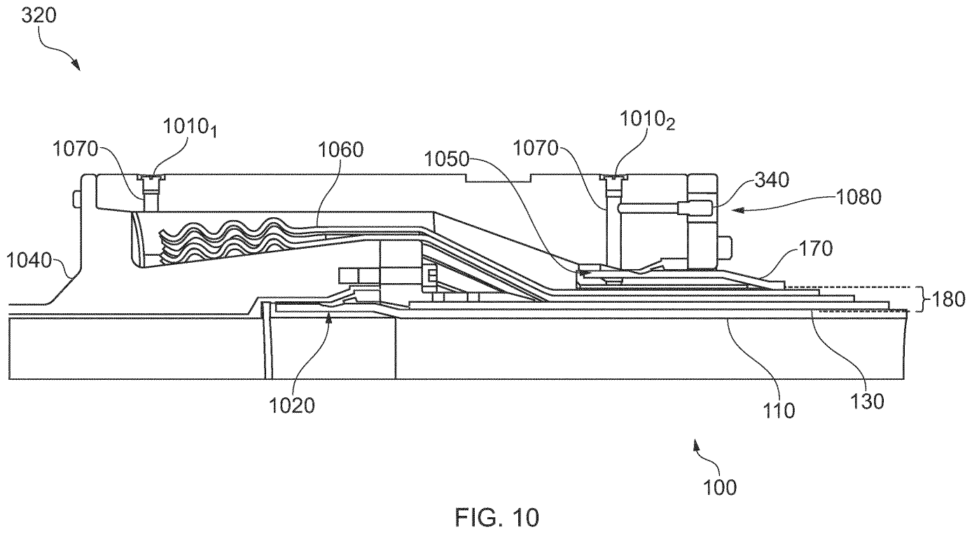

FIG. 10 illustrates an alternative of an end fitting with a purge outlet; and

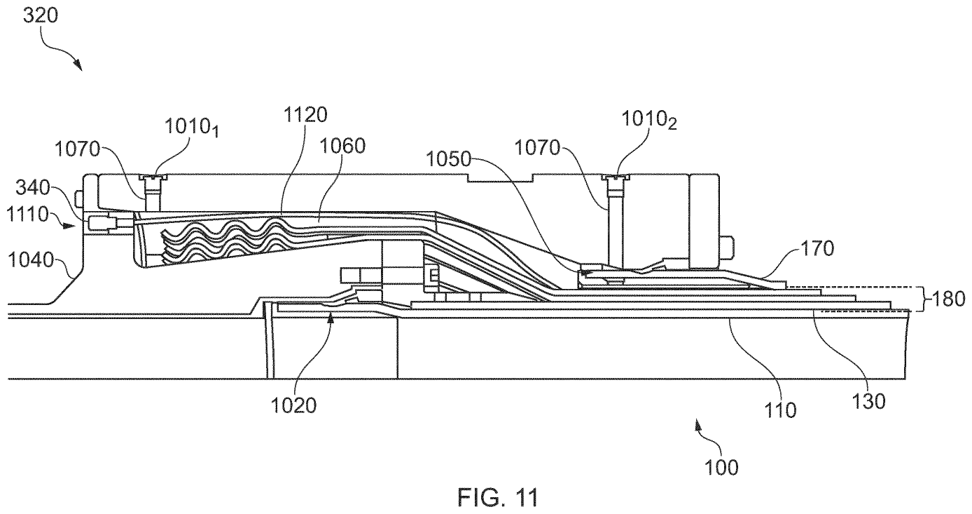

FIG. 11 illustrates another alternative of an end fitting with a purge outlet.

In the drawings like reference numerals refer to like parts.

Throughout this description, reference will be made to a flexible pipe. It is to be appreciated that certain embodiments of the present invention are applicable to use with a wide variety of flexible pipe. For example certain embodiments of the present invention can be used with respect to flexible pipe body and associated end fittings of the type which is manufactured according to API 17J. Such flexible pipe is often referred to as unbonded flexible pipe. Other embodiments are associated with other types of flexible pipe.

It will be understood that the illustrated flexible pipes are an assembly of a portion of flexible pipe body and one or more end fittings (not shown) in each of which a respective end of the pipe body is terminated. FIG. 1 illustrates how pipe body 100 is formed from a combination of layered materials that form a pressure-containing conduit. Although a number of particular layers are illustrated in FIG. 1, it is to be understood that certain embodiments of the present invention are broadly applicable to coaxial pipe body structures including two or more layers manufactured from a variety of possible materials. The pipe body may include one or more layers comprising composite materials, forming a tubular composite layer. It is to be further noted that the layer thicknesses are shown for illustrative purposes only. As used herein, the term “composite” is used to broadly refer to a material that is formed from two or more different materials, for example a material formed from a matrix material and reinforcement fibres.

A tubular composite layer is thus a layer having a generally tubular shape formed of composite material. Alternatively, a tubular composite layer is a layer having a generally tubular shape formed from multiple components one or more of which is formed of a composite material. The layer or any element of the composite layer may be manufactured via an extrusion, pultrusion or deposition process, or by a winding process in which adjacent windings of tape which themselves have a composite structure are consolidated together with adjacent windings. The composite material, regardless of manufacturing technique used, may optionally include a matrix or body of material having a first characteristic in which further elements having different physical characteristics are embedded. That is to say elongate fibres which are aligned to some extent or smaller fibres randomly orientated can be set into a main body or spheres or other regular or irregular shaped particles can be embedded in a matrix material, or a combination of more than one of the above. Aptly the matrix material is a thermoplastic material, aptly the thermoplastic material is polyethylene or polypropylene or nylon or PVC or PVDF or PFA or PEEK or PTFE or alloys of such materials with reinforcing fibres manufactured from one or more of glass, ceramic, basalt, carbon, carbon nanotubes, polyester, nylon, aramid, steel, nickel alloy, titanium alloy, aluminium alloy or the like or fillers manufactured from glass, ceramic, carbon, metals, buckminsterfullerenes, metal silicates, carbides, carbonates, oxides or the like.

The pipe body 100 illustrated in FIG. 1 includes an internal pressure sheath 110 which acts as a fluid retaining layer and comprises a polymer layer that ensures internal fluid integrity. The layer provides a boundary for any conveyed fluid. It is to be understood that this layer may itself comprise a number of sub-layers. It will be appreciated that when a carcass layer 120 is utilised the internal pressure sheath is often referred to by those skilled in the art as a barrier layer. In operation without such a carcass (so-called smooth bore operation) the internal pressure sheath may be referred to as a liner. A barrier layer 110 is illustrated in FIG. 1.

It is noted that a carcass layer 120 is a pressure resistant layer that provides an interlocked construction that can be used as the innermost layer to prevent, totally or partially, collapse of the internal pressure sheath 110 due to pipe decompression, external pressure, and tensile armour pressure and mechanical crushing loads. The carcass is a crush resistant layer. It will be appreciated that certain embodiments of the present invention are thus applicable to ‘rough bore’ applications (with a carcass). Aptly the carcass layer is a metallic layer. Aptly the carcass layer is formed from stainless steel, corrosion resistant nickel alloy or the like. Aptly the carcass layer is formed from a composite, polymer, or other material, or a combination of materials and components. The carcass layer is usually radially positioned within the barrier layer.

The carcass layer is a “layer” in the sense that a radially innermost and outermost surface are created in single pass at a single manufacturing node. The single manufacturing node may include multiple tape handling sections axially close together so that they are effectively a single node. The node aptly extends over an axial distance of less than 2.5 m. Aptly the node has a length of 1 m or less.

The pipe body includes a pressure armour layer 130 that is a pressure resistant layer that provides a structural layer that increases the resistance of the flexible pipe to internal and external pressure and mechanical crushing loads. The layer also structurally supports the internal pressure sheath. Aptly as illustrated in FIG. 1 the pressure armour layer is formed as a tubular layer. Aptly for unbonded type flexible pipe the pressure armour layer consists of an interlocked construction of wires with a lay angle close to 90°. Aptly in this case the pressure armour layer is a metallic layer. Aptly the pressure armour layer is formed from carbon steel, aluminium alloy, stainless steel or the like. Aptly the pressure armour layer is formed from a pultruded composite interlocking layer. Aptly the pressure armour layer is formed from a composite formed by extrusion or pultrusion or deposition. A pressure armour layer is positioned radially outside an underlying barrier layer.

The flexible pipe body also includes a first tensile armour layer 140 and second tensile armour layer 150. Each tensile armour layer is used to sustain tensile loads and optionally also internal pressure. Aptly for some flexible pipes the tensile armour windings are metal (for example steel, stainless steel or titanium or the like). For some composite flexible pipes the tensile armour windings may be polymer composite tape windings (for example provided with either thermoplastic, for instance nylon, matrix composite or thermoset, for instance epoxy, matrix composite). For unbonded flexible pipe the tensile armour layer is formed from a plurality of wires (to impart strength to the layer) that are located over an inner layer and are helically wound along the length of the pipe at a lay angle typically between about 10° to 55°. Aptly the tensile armour layers are counter-wound in pairs. Aptly the tensile armour layers are metallic layers. Aptly the tensile armour layers are formed from carbon steel, stainless steel, titanium alloy, aluminium alloy or the like. Aptly the tensile armour layers have a microstructure that consists of orientated lamellae. Aptly the tensile armour layers are formed from a composite, polymer, or other material, or a combination of materials.

Aptly the flexible pipe body includes optional layers of tape 160 which help contain underlying layers and to some extent prevent abrasion between adjacent layers. A tape layer may optionally be a polymer or composite or a combination of materials, also optionally comprising a tubular composite layer. Tape layers can be used to help prevent metal-to-metal contact to help prevent wear. Tape layers over tensile armours can also help prevent “birdcaging” of the tensile armour wires.

The flexible pipe body also includes optional layers of insulation 165 and an outer sheath 170, which comprises a polymer layer used to protect the pipe against penetration of seawater and other external environments, corrosion, abrasion and mechanical damage. Any thermal insulation layer helps limit heat loss through the pipe wall to the surrounding environment. An annulus region 180 is defined as the space between the internal pressure sheath 110 and the outer sheath 170. In other words, in the flexible pipe body illustrated in FIG. 1, the pressure armour layer 130, the first tensile armour layer 140, the further tensile armour layer 150, the optional layers of tape 160, and the optional layers of insulation 165 are located in the annulus region 180. It will be appreciated that in some embodiments, the annulus region 180 may contain any or none of the layers present in the flexible pipe body illustrated in FIG. 1.

Each flexible pipe comprises at least one portion, referred to as a segment or section, of pipe body 100 together with an end fitting located at at least one end of the flexible pipe. A respective end fitting may be used to terminate each end of the flexible pipe body. An end fitting provides a mechanical device which forms the transition between the flexible pipe body and a connector. The different pipe layers as shown, for example, in FIG. 1 are terminated in the end fitting in such a way as to transfer the load between the flexible pipe and the connector.

FIG. 2 illustrates a pipeline 200 suitable for transporting production fluid such as oil and/or gas and/or water from a sub-sea location 221 to a Pipe Lay Support Vessel (PLSV) 222. In FIG. 2, the PLSV may be a ship. For example, in FIG. 2 the sub-sea location 221 includes a sub-sea flow line 225. The flexible flow line 225 comprises a flexible pipe, wholly or in part, resting on the sea floor 230 or buried below the sea floor and used in a static application. In some alternatives, the PLSV may be provided by a platform. In other alternatives the PLSV may be provided by a floating platform. The pipeline 200 is an assembly. That is to say a plurality of flexible pipes 240 extending between the PLSV 222 to the sea floor. The pipeline 200 has six flexible pipes, 240₁, 240₂, 240₃, 240₄, 240₅, and 240₆. In the pipeline 200, neighbouring flexible pipes 240 are joined by securing their end fittings together in an end-to-end configuration. It will be appreciated that in other examples, the pipeline 200 may alternatively have any number of flexible pipes 240.

In earlier use some of the pipeline may have been used as a riser and some as a flowline. For example it will be appreciated that there are different types of riser, as is well-known by those skilled in the art. Certain embodiments of the present invention may be used with retrieval of any type of riser, such as a freely suspended (free-hanging, catenary riser), a riser restrained to some extent (buoys, chains), totally restrained riser or enclosed in a tube (I or J tubes). Some, though not all, examples of such configurations can be found in API 17J. Portions of flexible pipe that can be retrieved can also previously have been utilised as a jumper.

It will be understood that some sections 240 of the pipeline assembly may include thermoplastic composite pipe, i.e. a pipe with a structure at least partly made from a composite material. Optionally the pipeline assembly including thermoplastic composite pipe may be referred to as a thermoplastic composite pipeline. Optionally a thermoplastic composite pipe may include a plurality of bonded tape layers to provide a pipe of the desired wall thickness and strength (axially and in relation to internal pressure). Optionally the thermoplastic composite pipe may also include additional thermoplastic tubular (typically extruded) layers radially inside and/or outside of the composite material. Optionally the thermoplastic tubular layers are bonded to the composite material layer of the thermoplastic composite pipe. Optionally the thermoplastic composite pipeline may not have an annulus, in which and through which permeated gas can accumulate and percolate to an end fitting. Optionally some thermoplastic composite pipeline may not have an annulus at least in part, so there may be no option to through-connect the annuli of flexible pipes either side of the thermoplastic composite pipe section in order to relieve a higher annulus pressure in one or other flexible pipe section, via a fluid connection, to a lower annulus pressure in another flexible pipe section.

FIG. 3 illustrates a lower flexible pipe 240₂ including flexible pipe body 100 (part shown in FIG. 3) and an end fitting 320. Flexible pipe body 100 includes the internal pressure sheath 110, carcass layer 120, pressure armour layer 130, first tensile armour layer 140, second tensile armour layer 150, optional tape layers 160, optional insulating layers 165, and the outer sheath 170. The annulus region 180 is defined as the space between the internal pressure sheath 110 and the outer sheath 170. In other words, as shown in FIG. 3, the annulus region 180 includes the pressure armour layer 130, first tensile armour layer 140, second tensile armour layer 150, optional tape layers 160, and optional insulating layers 165. It will be appreciated that in some embodiments, flexible pipe body 100 may contain any combination of the layers previously described.

The end fitting 320 is a hollow steel part that is broadly cylindrical in shape. In other words, the end fitting 320 is substantially rotationally symmetrical. The end fitting 320 is assembled from constituent parts. Optionally, the end fitting 320 may be manufactured from a metal billet that is milled or turned. It will be appreciated that in some alternatives, the end fitting 320 may be constructed from another metal, metal composite, alloy, or the like. The end fitting 320 has an open mouth 322. The open mouth 322 has an internal diameter that corresponds to an outer diameter of flexible pipe body. The open mouth 322 also has a depth of at least 0.5 m. In some end fittings 320, the open mouth 322 has a depth of at least 1 m. The end fitting also includes a neck 324. The neck 324 is a hollow tubular shape that terminates in a flange 326. The flange 326 is plate-shaped, with an axial length (thickness) of less than 0.1 m. Some flanges 326 have axial length less than 0.2 m. The flange 326 has a greater outer diameter than the outer diameter of the neck 324. The flange 326 has two through-holes in its thickness to help facilitate pre-tensioned fasteners for connecting the two adjacent flanges 326, whereby the distance from the central axis of the flange 326 to the through-hole is greater than the radius of the neck 324. It will be appreciated that in some end fittings 320, the number of through-holes in the flange 320 may be 1, or 3, or 4, or a number greater than 4. A gasket seal ring (not shown), for instance a API 6A type BX ring is trapped between the flanges 326 and located in recessed seal ring grooves present in each flange. Other sealing systems and flange connection designs will be known to those skilled in the art. It will be appreciated that in some examples, a gasket may not be used.

The end fitting 320 of the lower flexible pipe 240₂ (the lower end fitting shown in FIG. 3) abuts an upper end fitting 330 in FIG. 3 of an adjacent flexible pipe in an end-to-end configuration. The upper end fitting 330 has the open mouth 322, neck 324, and flange 326 as described previously. The first end fitting 320 is secured to the upper end fitting 330 using fasteners in the through-holes of the flanges 326. It will be appreciated that in other embodiments, another method of fastening may be used to secure the end fitting 320 and the upper end fitting 330 together. The lower flexible pipe 240₂ is attached, via its end fitting 320, to another flexible pipe 240₁ (not shown), via the upper end fitting 330, such that bore fluid may flow freely from the flexible pipe 240 to the further flexible pipe (not shown) through the end fittings 320, 330.

In the end fitting 320, the internal pressure sheath 110 and outer sheath of flexible pipe body 100 are sealed via seal rings while the other layers are terminated to provide mechanical load transfer. The internal pressure sheath is sealed using at least one seal ring at its terminus inside the end fitting such that bore fluid is prevented from leaking into the annulus. Similarly, the outer sheath is sealed using another seal ring at its terminus inside the end fitting such that seawater or the like is prevented from leaking into the annulus. The layers inside the annulus region 180 are terminated inside the end fitting in a chamber. A pressure release valve 335 is located on the end fitting 320. The pressure release valve is a purge valve. The pressure release valve 335 has a purge outlet (not shown). The purge outlet is an opening in the pressure release valve 335. In some examples, the purge outlet may be an opening in the end fitting 320. The purge outlet provides an exit for gasses from the end fitting 320 to be outputted. It will be appreciated that sometimes, the pressure release valve 335 may instead be the purge outlet. For example, the pressure release valve 335 may be a through hole. An adapter is secured on an end of the pressure release valve 335 in the outer surface of the end fitting 320. On a further end of adapter is an upper pressure release valve 345. The top of the upper pressure release valve 345 includes the purge outlet 340. This is illustrated in more detail FIG. 4.

There is fluid pressure on the upper pressure release valve 345. On a first (outer) side of the upper pressure release valve 345, the pressure is equal to a local water pressure (WP). It will be appreciated, for example, that as depth below sea level increases by 10 m, WP will increase by about 1 bar. On a further (inner towards the pipe annulus) side of the upper pressure release valve 345, fluid pressure is equal to gas (or other fluid) pressure in the annulus region 180 due to gases in the annulus region 180. Gas pressure in the annulus region 180 may be referred to as annulus pressure. The upper pressure release valve 345 has a threshold pressure difference. At the threshold pressure difference, a linear spring will be compressed by the pressure and thus the pressure release valve will open to allow the higher pressure annulus gases to be released. The threshold pressure difference is typically around 2 bar. It will be appreciated that sometimes, the threshold pressure difference may be less than 2 bar. In other examples, the threshold pressure difference may be greater than 2 bar. Aptly the pressure difference is 3 bar. Aptly the pressure difference is from 2 to 10 bar. When annulus pressure (AP) is greater than the local water pressure (WP) and threshold pressure difference combined, where SP may be considered the re-seat pressure difference for the pressure release valve, the upper pressure release valve 345 will open and enable gases in the annulus region 180 to be released. Consequently, annulus pressure will decrease until AP is equal or less than WP and SP combined, at the pressure release valve 345. The re-seat pressure difference SP may be equal to a pressure between 0 and the threshold pressure difference. This helps to provide a positive pressure difference, i.e. it ensures AP is always greater than WP by at least SP.

In FIG. 3, there is a module 350 on the outer surface of the end fitting 320. The module 350 is mounted to the end fitting using straps that encircle the end fitting. It will be appreciated that the module 350 could instead be bolted, adhered, welded, or the like to the end fitting 320. It will be appreciated that in some alternatives such as those illustrated in FIG. 8 or FIG. 9, the module 350 may not be attached to the end fitting 320. The module 350 is in fluid communication, via a tube 360, with the pressure release valve 335 and the upper pressure release valve 345. Specifically, the module 350 is in fluid communication with the outer side of the pressure release valve 335. The tube 360 is made of a rubber construction, optionally with reinforcements to provide pressure and/or collapse resistance. It will be appreciated that in other alternatives, the tube may be manufactured using a different process, or out of a different material, for example stainless steel, or the like. The module 350 is in fluid communication with the inner side of the upper pressure release valve 345. Therefore, the annulus pressure (AP) is equal to the pressure recorded in the module 350. The module 350 has an enclosure, also referred to as an outer housing. The housing is watertight and rigid so as to be crush resistant. The housing contains and supports a first pressure sensor 370 capable of measuring fluid pressure and a further pressure sensor 380 capable of measuring fluid pressure. There is a through hole in the otherwise fluid tight outer housing of the module 350 which can enable the further pressure sensor to be in contact with seawater surrounding the module 350. The water pressure of a local environment is thus in fluid communication with the sensor. The module 350 is capable of communicating an annulus pressure value (APV) received from the first pressure sensor 370 to the PLSV 222. The module 350 is also capable of communicating a local water pressure value (WPV) received from to the PLSV 222. The APV and WPV may be collectively referred to as data. The data is communicated wirelessly to the PLSV using a subsea ultrasonic wireless communication system. Optionally, a time value may also be recorded. It will be appreciated that data is transferred in different ways and to different destinations. It will also be appreciated that in some alternatives, the time value is included as data. It will be appreciated that in some alternatives, a different wireless communication technology may be used. In other alternatives, a wired communication technology may be used to communicate data from the module 350 to the PLSV 222. In yet further alternatives, a wired communication technology may be used to communicate data from the module 350 to an ROV. Optionally, the annulus pressure values recorded by the annulus pressure sensor may be recorded or saved onto a storage medium in the module 350, eg a hard drive, flash storage, or the like. Optionally, the local water pressure values recorded by the local water pressure sensor may be recorded or saved onto a storage medium in the module 350, eg a hard drive, flash storage, or the like. Optionally, the time values associated with annulus pressure values and/or local water pressure values may be recorded or saved onto a storage medium in the module 350, eg a hard drive, flash storage, or the like.

FIG. 4 illustrates another view of the end fitting 320, showing more detail of the pressure release valve 335 that protrudes from the end fitting 320. The pressure release valve 335 may be a legacy (pre-existing) pressure release valve fitted to the end fitting 320. The top surface of the pressure valve 335 has the purge outlet 340. Alternatively, the pressure release valve 335 may be fitted on a new flexible pipe. Alternatively the pressure release valve 335 is a conventional purge outlet such as, but not limited to, a prior art purge valve of a type known to be usable on an end fitting or a flexible pipe. An adapter 410 is attached to the first generally cylindrical shape with a hollow chamber 420. The adapter includes a though-hole 430, an adapter body 440, the tube 360, and the upper pressure release valve 345. The through-hole 430 is an opening. It will be appreciated that in some alternatives the adapter 410 is made from a plastic material or rubber or non-plastic material, or a combination of materials. The pressure release valve 335 is secured to the bottom side of the adapter 410 in FIG. 4. The upper pressure release valve 345 is provided with the purge outlet 340. The upper pressure release valve 345 is fixed to the adapter 410 at a further end of the adapter 410. The through-hole 430 is located halfway along the adapter body 440. The tube 360 is secured in the through-hole 430 by friction fit and by sealing with epoxy to prevent leaks. In some examples the tube 360 is secured in the through-hole using a flange, adhesive material, or the like. The tube 360 may be sealed by an adhesive, or the like. The through-hole 430 provides fluid communication between the chamber 420 and the tube 360. It will be appreciated that fluid communication means an open pathway for a fluid to flow.

The adapter 410 is retrofitted onto the end fitting 320 with the pressure release valve 335. During installation, the adapter body 440 is secured around the pressure release valve 335 by friction. In other words, a pressure fit holds the adapter 410 onto the pressure release valve 335. A seal 450 is provided between the adapter body 440 and the pressure release valve 335. The seal 450 includes a polymeric sealing element. It will be appreciated that in some alternatives, the seal 450 may include a metallic material, a composite material, or the like. The adapter body 440 is generally cylindrical in shape. It will be appreciated that in some examples, an alternative securing method such as a screw thread, pin, needle head or the like may be used to hold the adapter 410 around the pressure release valve 335. In some examples, the adapter 410 may not attach to the pressure release valve 335. Optionally, the adapter 410 may be retrofitted to the end fitting 320 using a remotely operated vehicle (ROV). Alternatively the adapter (and module) might be fitted on installation of a pipeline. The adapter 410 includes the tube 360 and the upper pressure release valve 345. The adapter 410 is constructed of rubber and has a generally cylindrical shape with a hollow chamber 420. It will be appreciated that sometimes the adapter 410 is made from a non-plastic material, or a combination of materials. The pressure release valve 335 is located at a first end of the adapter 410. The upper pressure release valve 345 is fixed to the adapter 410 at a further end of the adapter 410. The adapter 410 also has the through-hole 430 halfway along its length. The tube 360 is secured on the outer cylindrical surface of the adapter 410. The through-hole 430 provides fluid communication between the chamber 420 and the tube 360. It will be appreciated that fluid communication means an open pathway for a fluid to flow.

The adapter 410 is retrofitted onto the end fitting 320 with protruding pressure release valve 335. During installation, an adapter body 440 is secured around the pressure release valve 335 by friction. In other words, a pressure fit holds the adapter 410 onto the pressure release valve 335. A seal 450 is provided between the adapter body 440 and the pressure release valve 335. The seal 450 includes a polymeric sealing element. It will be appreciated that the seal 450 could include a metallic material, a composite material, or the like. The adapter body 440 is generally cylindrical in shape. It will be appreciated that sometimes, an alternative securing method such as a screw thread, pin, needle head or the like may be used to hold the adapter 410 around the pressure release valve 335. In some examples, the adapter 410 may not attach to the pressure release valve 335.

When underwater, the upper pressure release valve 345 is in contact with water. Thus, the outlet 345 is exposed to the local water pressure. The annulus pressure, from gases in the annulus region 180, is transferred through the pressure release valve 335 to the chamber 420. Consequently, the inner side of the upper pressure release valve 345 is exposed to the annulus pressure. Annulus gases also enter the tube 360, therefore, the pressure in the tube 360 is equal to the annulus pressure.

In FIG. 5 the pipeline 200 is illustrated as being retrieved by the pipe lay support vessel (PLSV) 222. During retrieval of the pipeline 200, each flexible pipe is lifted through water towards the PLSV. A similar arrangement may be shown in FIG. 2. End-to-end connections 510 are shown; the end-to-end connection 510 includes a pair of the end fittings 320 secured together in an end-to-end configuration. The end fitting 320 of each connection (the end fitting which is lower in the water/most distant of a pair from the lift point) includes the pressure release valve 345, the adapter 410, and the module 350. By joining multiple flexible pipes 240₁, 240₂, etc in this way, the pipeline 200 is assembled/formed. Flexible pipes 240 in the pipeline 200 are wound onto a spool (not shown) on the PLSV as they are retrieved. Aptly a respective spool is used for each flexible pipe of the pipeline. Therefore, the flexible pipes 240 are withdrawn from their resting position in the sea onto the PLSV. The speed of rotation of the spool thus determines a flexible pipe retrieval velocity of the pipeline 200. The flexible pipe retrieval velocity may be a flexible pipe retrieval speed. As mentioned previously in respect of the prior art, there is a safe limit to the flexible pipe retrieval velocity, above which flexible pipe body may burst: as flexible pipe body is raised to closer to sea level, local water pressure reduces. Local water pressure reduces at a rate of roughly 1 bar per 10 m of depth below sea level lost. The outer sheath 170 of flexible pipe body is liable to bursting if pressure in the annulus region 180—the annulus pressure—exceeds local water pressure by more than a pressure limit of the outer sheath 170. Thus, the outer sheath 170 will burst due to excess internal pressure. Purge outlets 340 in the pressure release valve 335 help to reduce annulus pressure, when the annulus pressure exceeds the local water pressure by a predetermined value. The purge outlets 340 have a maximum output rate at which the purge outlets 340 can purge fluid and thus exhaust annulus gases into the seawater. If the flexible pipe retrieval velocity is too great, there is a risk that local water pressure will decrease too quickly, and thus excess internal pressure will accumulate and the outer sheath 170 will burst. In other words, the flexible pipe retrieval velocity is sometimes affected by the rate at which pressure release valves 335 can reduce annulus pressure.

Certain embodiments of the present invention help obviate such a risk. It will be appreciated that the flexible pipe retrieval velocity may be constant. In some alternatives, the flexible pipe retrieval velocity is variable. In other words, in some examples, the flexible pipe retrieval velocity may vary continuously. In the context of flexible pipe retrieval velocity, continuously means the variable is able to change every millisecond, or every second, or every minute, or every hour, or periodically or repeatedly or at given periods or the like.

A maximum advisable retrieval velocity is used to ensure that the outer sheath 170 does not burst due to excess pressure in the annulus region 180. For example, when annulus pressure is dangerously high and must be reduced, flexible pipe retrieval velocity is set so that it does not exceed the maximum rate at which pressure release valves 335 can reduce annulus pressure. The flexible pipe retrieval velocity may be constantly changing. The maximum advisable retrieval velocity may also be referred to as a maximum advisable retrieval speed. The maximum advisable retrieval velocity is determined according to a formula:

$$AP < WP + SM \qquad 1$$

Where AP is the annulus pressure, WP is the local water pressure, and SM is a safety margin. The AP is determined proximate to the pressure release valve 335. In other words, the measure of AP, using the first pressure sensor 370, is taken close to the pressure release valve 335 by introducing a fluid connection between the pressure release valve 335 and the sensor 370. In other words, the fluid connection exists between the purge outlet 340 and the sensor 370. Aptly the value of WP is determined within 0.5 m of the purge valve. Aptly the distance is within 2 m. Aptly the WP value is within 20 m of the purge valve. AP values (APVs) are recorded from the first pressure sensor 370. It will be appreciated that in some examples, AP could be measured by direct fluid connection to the annulus region 180 of flexible pipe body. In some examples, the first pressure sensor 370 can sense pressure from 0 bar to the order of 300 bar or greater. The local water pressure (WP) is the measure of WP, recorded by the further pressure sensor 380, in a region proximate to the purge outlet. For example, in some examples, the further pressure sensor 380 is less than around 5 m from the purge outlet and optionally the further pressure sensor 380 is less than around 1 m from the purge outlet. In some examples, the further pressure sensor 380 can sense pressure from 0 bar to the order of 300 bar or greater. WP values (WPVs) are recorded from the further pressure sensor 380. The safety margin SM is a predetermined additional pressure value. In other words, the SM may be set to any pressure value by a human operator. In some examples, the SM may be set to any pressure value by a computer programme. In other examples, the SM may be set to a pressure value by either a human operator or a computer programme. The SM is at least 2 bar in the present embodiment. It will be appreciated that sometimes, the SM may be at least 3 bar, or at least 4 bar, or the like. Optionally, the SM may include a valve crack pressure (VCP). In other words, the SM may optionally be a sum of the threshold pressure difference between: the first side of the pressure release valve 335 and the further side of the pressure release valve 335; and a further pressure value.

It will be appreciated that in some examples, the formula 1 may alternatively be:

$$AP < WP \pm SM$$

where AP is annulus pressure proximate to the purge outlet, WP is local water pressure proximate to the purge outlet 340, and SM is the predetermined safety margin which may be a positive or negative number.

Annulus pressure values (APVs) recorded from the first pressure sensor 370 are transmitted by the module 350 to the PLSV 222. In other words, APVs are sent via a subsea ultrasonic wireless communication 520 to the PLSV. The subsea ultrasonic wireless communication 520 is transmitted by a subsea ultrasonic wireless system (not shown). The subsea ultrasonic wireless system is included in the module 350. Local water pressure values (WPVs) recorded from the further pressure sensor 380 are transmitted by the module 350 to the PLSV 222. In other words, WPVs are sent via the subsea ultrasonic wireless communication 520 to the PLSV 222. It will be appreciated that in some alternative examples, wireless communications using sound frequencies below 20 kHz, visible light, microwaves, infrared, ultraviolet, or the like may be used to transmit APVs, WPVs, APVs and WPVs, or other sensor or sensor-related data.

Data transmitted from the module 350 associated with the end fitting 320 is used to determine the maximum advisable retrieval velocity. In the pipeline 200 shown in FIG. 5, the maximum advisable retrieval velocity is calculated every millisecond using the formula 1 above. Optionally, the maximum advisable retrieval velocity may be calculated more frequently than every millisecond. In other examples, the maximum advisable retrieval velocity may be calculated less frequently than every millisecond, for example, every 1 second, every 10 seconds, every minute, every 10 minutes, every hour, or the like. During pipe retrieval, the maximum advisable retrieval velocity is initially set to 1 m/hour. Then, when the maximum advisable retrieval velocity is recalculated one millisecond later, if the formula, AP<WP+SM, is still satisfied (true), the maximum advisable retrieval velocity is incremented by 1 m/hour. Every millisecond the maximum advisable retrieval velocity is recalculated. If, when the maximum advisable retrieval velocity is recalculated one millisecond later, the formula, AP<WP+SM, is not satisfied (false), the maximum advisable retrieval velocity is decremented by 1 m/hour. In other words, the maximum advisable retrieval velocity is adjusted depending on whether the formula is satisfied. Optionally, the maximum advisable retrieval velocity may be incremented by 0.1 m/hour, or 10 m/hour, or 30 m/hour, or the like. Likewise, it will be appreciated that in some examples, the maximum advisable retrieval velocity may be decremented by 0.1 m/hour, or 10 m/hour, or 30 m/hour, or the like. The flexible pipe retrieval velocity is then set to the maximum advisable retrieval velocity continuously. Here continuous means adjusted every millisecond, or every second, or every minute, or the like.

Determination of velocity to be used may alternatively be carried out on the occurrence of an event rather than at common repeated times. It will be appreciated that sometimes, a feedback control system may be used to help set and vary the maximum advisable retrieval velocity, the flexible pipe retrieval velocity or both. It will be appreciated that other methods may be used to set or determine the maximum advisable retrieval velocity.

It will be appreciated that in some examples additional data such as a maximum flow rate of pressure release valve 335, further data derived from WPV, further data derived from APV, or the like may be used to determine the flexible pipe retrieval velocity. Optionally, a rate of change of APV is calculated from recent APVs. Optionally, a rate of change of WPV is calculated from recent WPVs. Using SP, APV, WPV, rate of change of APV, and rate of change of WPV, the maximum advisable retrieval velocity may be determined by estimation.

Alternatively, determining a maximum advisable retrieval velocity could involve any of the following steps: setting the maximum advisable retrieval velocity to 1 m/hour, or 2 m/hour, or 10 m/hour, or 100 m/hour, or more, initially; monitoring the annulus pressure and/or local water pressure during pipe retrieval every millisecond, or every microsecond, or every second, or every minute, or the like; where if, during monitoring, AP is decreasing per unit of time (rate of change of AP is decreasing) during retrieval at a slower rate than WP is decreasing per unit of time (rate of change of WP is decreasing) during retrieval, then the maximum advisable retrieval speed is reduced by 1 m/hour, or 2 m/hour, or 10 m/hour, or 100 m/hour, or more; or where if, during monitoring, AP is decreasing per unit of time (rate of change of AP is decreasing) during retrieval at the same or higher rate than WP is decreasing per unit of time (rate of change of WP is decreasing) during retrieval then the maximum advisable retrieval velocity is increased by 1 m/hour, or 2 m/hour, or 10 m/hour, or 100 m/hour, or more. It will be appreciated that the unit of time may be long enough for pressure to have built up sufficiently to open the release valve/s on a flexible pipe at least once between monitoring intervals.

FIG. 6 illustrates a flow chart of a flexible pipe retrieval process 600 according to the flexible pipe and pipeline and purge outlets illustrated in FIGS. 1-5. It will be appreciated that in alternative examples, such as those illustrated in FIGS. 7-11, the flexible pipe retrieval process 600 will remain broadly the same, subject to any changes detailed in the alternative examples. In a first step S601 the pipe lay support vessel 222 is located at sea level in the vicinity of the pipeline 200. The pipeline 200 is located in its subsea position prior to retrieval. That is to say, in S601, the pipeline 200 containing flexible pipes 240₁ to 240₆ inclusive is in the position it was installed in (possibly many years earlier).

In a step S605, the module 350 and adapter 410 are installed onto the selected end fittings 320 of the flexible pipes 240 in the pipeline 200. The adapter 410 is secured onto the pressure release valves 335 protruding from the end fittings 320. This can be achieved via ROV or diver or the like depending on water depth and other environmental factors. For each flexible pipe in the pipeline 200, a fluid connection is established between the annulus region 180 of the flexible pipe 240 and the module 350 via the tube 360. The first hydrostatic pressure sensor 370 is exposed to the annulus pressure (AP). The further hydrostatic pressure sensor 380 is exposed to the local water pressure (WP) proximate to the end fitting 320. The first hydrostatic pressure sensor 370 outputs data in the form of annulus pressure values (APVs). The further hydrostatic pressure sensor 380 outputs data in the form of local water pressure values (WPVs). As illustrated in FIG. 5, data is transmitted from the modules 350 on end fittings 320 to the PLSV 222. It will be appreciated that in some alternatives, data may be communicated from the module 350 to the PLSV 222 using wired communication, an ROV, alternative wireless communications, or the like. In some situations, step S605 may involve stabbing a probe into the end fitting 320. Therefore, fluid communication is established between the annulus region 180 of the flexible pipe 240 and the module 350. In some situations, the module 350 may not be mounted onto the end fitting 320.

In a step S610, the method of retrieving underwater flexible pipe is initiated. One end of the pipeline 200, that is one end of a first flexible pipe 240₁ in the pipeline, is secured and lifted towards the PLSV. In other words, one end of the flexible pipe 240₁ is urged towards the PLSV. A remotely operated vehicle (ROV) is used to access one end of the first flexible pipe 240₁. The ROV attaches a cable to the end fitting 320 on the first flexible pipe 240₁ in the pipeline 200. Thus, the pipeline 200 is winched up through the water towards the PLSV 222. It will be appreciated that sometimes, alternative methods may be used to recover one end of the pipeline 200. In a step S615, the rotation of the spool, and thus pipe retrieval, is halted whilst the end fitting 320 of the first flexible pipe 240₁ of the pipeline 200 is removed and/or the first flexible pipe 240₁ is secured to a spool. The spool is located on the PLSV. The spool is a reel for holding flexible pipe body with a diameter of at least 2 m. It will be appreciated that in sometimes, the spool may have a diameter of 1 m, 3 m, 5 m, or the like.

In a step S620 the spool resumes rotation. In other words, flexible pipe retrieval is recommenced. It will be appreciated that vertical motion of the flexible pipes of the pipeline may be non-continuous. Whilst a flexible pipe is being lifted, the flexible pipe retrieval velocity will be non-zero; when the end fitting of the flexible pipe is lifted out of the water, the flexible pipe retrieval velocity will temporarily be zero. Once the first flexible pipe 240₁ has been retrieved, a next flexible pipe 240₂ will be retrieved onto a second spool in the same way as described in the step S615. This process will continue for the remaining flexible pipes 240₃, 250₄, etc. The spool is rotated by a motor, thereby rotating the spool at a rotational speed. In some examples the rotational speed may be measured in revolutions per hour. It will be appreciated that other units of rotational speed such as revolutions per minute, radians per second, or the like could be used instead. The rotation of the spool secured to the first flexible pipe 240₁ causes the first flexible pipe 240₁ to be lifted towards the PLSV 222. Consequently, the remaining length of the pipeline 200 is also lifted towards the PLSV 222. The rate of lifting of an end region of the first flexible pipe 240₁ is called the flexible pipe retrieval velocity. It will be appreciated that the rate of lifting of remaining flexible pipes 240_{3,4,5,6} in the pipeline 200 will also be called the flexible pipe retrieval velocity when considering the end region of the flexible pipe. The flexible pipe retrieval velocity is therefore selected by the rotational speed of the spool, which is determined by the speed of rotation of the motor. It will be appreciated that the flexible pipe retrieval velocity is also affected by external factors such as water current, changing weight of the pipeline 200 as it is lifted, or the like. The speed of rotation of the motor is adjusted by a computer program. Alternatively a user/operator on the PLSV or at a remote location may be provided with visual readouts of data and may be given the ability to set performance parameters (such as spool rotation speed) manually. Optionally, the speed of rotation of the motor may thus be adjusted by a human operator. In the step S620, the initial maximum advisable retrieval velocity is set to 1 m/hour. The initial flexible pipe retrieval velocity is set to 1 m/hour. It will be appreciated that in some examples, a feedback control system is used to help maintain the flexible pipe retrieval velocity to the value set. In other words, the motor rotating the spool is set to the rotational speed such that the flexible pipe retrieval velocity is initially 1 m/hour. It will be appreciated that in some examples, a different initial maximum advisable retrieval velocity may be used.

During lifting of the end region of the flexible pipe 240₁, in a step S625, data including annulus pressure value (APV) and local water pressure value (WPV) is communicated from the module 350 to the PLSV 222. Specifically, data is received by a computer system on the PLSV 222. The computer system on the PLSV continually monitors the APV received from the module 350. The computer system on the PLSV continually monitors the WPV received from the module 350. Here, continually means every microsecond (μS) the APV and WPV are checked to determine whether action should be taken. It will be appreciated that in some examples, continually may refer to every millisecond, every second, every minute, every hour, or the like. The values of annulus pressure (AP) and local water pressure (WP) are monitored according to the formula:

$$AP < WP + SM \qquad 1$$

where AP is annulus pressure proximate to the purge outlet, WP is local water pressure proximate to the purge outlet 340, and SM is the predetermined safety margin. It will be appreciated that in some examples, the APV and/or the WPV are monitored by a human operator. In the step S625 a logical value, TRUE or FALSE, is assigned to the equation depending on the latest APV and WPV. In other words, the AP and WP recorded by the sensors 370, 380 are used to determine whether the equation is true or false.

In a step S630, the computer system detects that the equation is true. In other words, WP+SM are greater than AP. In this situation, the maximum advisable retrieval velocity is incremented by 1 m/hour. Optionally, the maximum advisable retrieval velocity may be incremented by 0.005 m/hour, 0.1 m/hour, 2 m/hour, 10 m/hour, 100 m/hour, or the like.

In a step S635, the flexible pipe retrieval velocity is set at or within 10 m/hour below the new maximum advisable retrieval velocity. Optionally, the flexible pipe retrieval velocity may be set within 20 m/hour, 50 m/hour, or the like below the new maximum advisable retrieval velocity. It will be appreciated that in some examples, a feedback control system is used to help maintain the flexible pipe retrieval velocity to the value set.

Next the method will return to the step S625 and continuously monitor the APV and WPV again after 1 μS. As discussed previously, it will be appreciated that in some examples, the time delay between repeated monitoring of data including APV and WPV may be different.

In a step S640, the computer system detects that the equation is false. In other words, WP+SM are less than AP. In this situation, the maximum advisable retrieval velocity is decremented (decreased) by 1 m/hour. It will be appreciated that the maximum advisable retrieval velocity could be incremented by 0.005 m/hour, 0.1 m/hour, 2 m/hour, 10 m/hour, 100 m/hour, or the like.

In a step S645, the flexible pipe retrieval velocity is set at or within 10 m/hour below the new maximum advisable retrieval velocity. It will be appreciated that, the flexible pipe retrieval velocity could be set within 20 m/hour, 50 m/hour, or the like below the new maximum advisable retrieval velocity. A feedback control system could be used to help maintain the flexible pipe retrieval velocity to the value set. The method will then return to the step S625 and continuously monitor the APV and WPV again after 1 μS. As discussed previously, it will be appreciated that in some examples, the time delay between repeated monitoring of data including APV and WPV may be different.

Next the method will return to the step S625 and continuously monitor the APV and WPV again after 1 μS. As discussed previously, it will be appreciated that sometimes, the time delay between repeated monitoring of data including APV and WPV may be different.

FIG. 7 illustrates an alternative example of the adapter 410 secured onto the pressure release valve 335 of the end fitting 320. The adapter 410 in FIG. 7 has the chamber 420, the through-hole 430, the upper pressure release valve 345, the tube 360, and the adapter body 440. The adapter body 440 has an alternative shape to that illustrated in FIG. 4. The adapter 410 is constructed of rubber and has a generally cylindrical shape with a hollow interior including the chamber 420. It will be appreciated that the adapter 410 can be made from a non-plastic material, or a combination of materials. The adapter body 440 is made from a cylindrical body and a wide collar 720 that is on one end of the cylindrical body. The wide collar 720 has a diameter that is greater than a diameter of the cylindrical body. The wide collar 720 is in contact with the end fitting 320.

The adapter 410 is installed on the pressure release valve 335 protruding from the end fitting 320. During installation, the adapter body 440 is secured around the pressure release valve 335 by friction. In other words, a pressure fit holds the adapter 410 onto the pressure release valve 335. A seal 730 is provided between the adapter body 440 and the pressure release valve 335. The seal 730 includes a polymeric sealing element. It will be appreciated that in some examples, the seal 730 may include a metallic material, a composite material, or the like. It will be appreciated that in some examples, an alternative securing method such as a screw thread, pin, needle head or the like may be used to hold the adapter 410 around the pressure release valve 335. In some examples, the adapter 410 may not attach to the pressure release valve 335. In some examples, the wide collar 720 may be a flange that is secured using bolts into the end fitting 320.

FIG. 8 illustrates the pipeline 200 according to an alternative example. The pipeline 200 may be similar to the arrangement in FIG. 2. The pipeline 200 includes the flexible pipes 240₁ to 240₆; end-to-end connections 510, which include the end fitting 320 of the lower flexible pipe 240₂ secured to the end fitting 320 of an upper flexible pipe 240₁; the pipe lay support vessel (PLSV) 222; and a remotely operated vehicle (ROV) 810. The ROV 810 is a waterproof vehicle that can be operated from the PLSV 222. In other words, power and data are transferred from the PLSV 222 through a long-distance cable 820 to the ROV 810. It will be appreciated that in some situations, the ROV 810 may communicate wirelessly with the PLSV 222 and be powered from a portable power source such as a battery.

The end-to-end connection 510 includes the end fittings 320. The end fittings 320 include the pressure release valve 335, the adapter 410, and the module 350, as described in FIGS. 3 and 4. The module 350 as illustrated in FIG. 8 wirelessly transmits data including the annulus pressure value (APV) and local water pressure value (WPV). The APV and WPV are received by the ROV 810. In other words, data is wirelessly transmitted 830 from the module 350 to the ROV 810 using a modem. It will be appreciated that sometimes, the data may be wirelessly transmitted by a wireless protocol 830 from the module 350 to the ROV 810 using a different form of communication. Sometimes, the module 350 may display the APV on a display that can be read by a camera on the ROV 810. In some embodiments, the module 350 may display the WPV on the display that can be read by the camera on the ROV 810.

FIG. 9 illustrates an alternative embodiment. The lower flexible pipe 240₂ is attached, via an end-to-end connection 510, to the upper flexible pipe 240₁. The pressure release valve 335 is attached to the end fitting 320 as described previously. Further, the adapter 410 including the upper pressure release valve 345 is secured onto the pressure release valve 335. The tube 360 provides a fluid connection between the adapter 410 and the module 350. In FIG. 9, the module 350 is located on the ROV 810. The ROV is connected, via the long-distance cable 820, to the PLSV 222.

The adapter 410 is installed onto the pressure release valve 335 by the ROV 810. The first pressure sensor 370 detects the annulus pressure (AP) from the annulus of the flexible pipe 240 through the tube 360. The further pressure sensor 380 detects the local water pressure (WP) proximate to the end fitting 320. In other words, the module 350 located on the ROV 810 is nearby to the end fitting 320. The annulus pressure values (APVs) are sent from the first pressure sensor 370 to the module 350, to the ROV 810, and to the PLSV 222 via the long-distance cable 820. Similarly, the local water pressure values (WPVs) are sent from the first pressure sensor 370 to the module 350, to the ROV 810, and to the PLSV 222 via the long-distance cable 820. In other words, data including the APVs and WPVs are transmitted via the ROV 810 to the PLSV 222.

FIGS. 10 and 11 illustrate alternative examples of the flexible pipe 240. The flexible pipe 240 includes the end fitting 320 and flexible pipe body 100. Flexible pipe body 100 includes, from innermost to outermost: the internal pressure sheath 110, the annulus region 180, and the outer sheath 170. Flexible pipe body 100 in FIGS. 10 and 11 has a smooth bore. The annulus region 180 includes the pressure armour layer 130, the first tensile armour layer 140, and the further tensile armour layer 150. It will be appreciated that other layers may be present in the annulus region 180. The end fitting 320 is broadly cylindrical in shape, as illustrated, for example, in FIG. 3 and FIG. 9. In the end fitting 320 shown in FIGS. 10 and 11, the purge outlet 340 is an opening that is not part of the pressure release valve 335. The purge outlet 340 is recessed into the body of the end fitting 320. It will be appreciated that the purge outlet 340 may be referred to as a purge valve. The end fitting 320 has two fill ports: a first fill port 1010₁ and a second fill port 1010₂ that are sealed with epoxy. It will be appreciated that the filled ports 1010 may be made from a different material such as any polymer, or the like. It will be appreciated sometimes, there may be one fill port 1010 in the end fitting. In other examples, there may be more than two fill ports 1010 in the end fitting 320.

Flexible pipe body 100 is attached to the end fitting 320 by separating the layers of flexible pipe body 100 at an end portion of flexible pipe body and securing the layers to the end fitting 320. The internal pressure sheath 110 is terminated and is held in place by a friction fit in a first gripping region 1020. The internal pressure sheath 110 is gripped in the first gripping region 1020 between a first half of the end fitting 320 and a further half of the end fitting 320. Therefore, fluid is prevented from leaking from the inside of the internal pressure sheath 110 into the annulus region 180. The pressure armour layer 130 is terminated separately from the remainder of the layers in the annulus region 180. The outer sheath 170 is terminated and is held in place by a friction fit in a further gripping region 1050. Consequently, fluid is prevented from leaking from the outside of the outer sheath 170 into the annulus region 180. The annulus region 180 is therefore sealed from fluid ingress on both sides. An epoxy housing 1060 in the end fitting 320 fills open space inside which the layers of the annulus region 180 are terminated. The epoxy housing 1060 is filled by pumping epoxy into the first fill port 1010₁. Excess epoxy is purged through the second fill port 1010₂. Once the epoxy has hardened inside the end fitting 320, venting columns 1070 opened by drilling through the epoxy. Gases in the annulus region 180 are able to pass into a venting column 1070. Gases in the venting column 1070 may be exhausted through the purge outlet 340. In the end fitting 320 in FIG. 10, the configuration of the purge outlet 340 may is a back-end venting system 1080. It will be appreciated that some end fittings 320 may have more than one purge outlet 340. Through the venting columns 1070, annulus gases are also able to reach the fill ports 1010. The fill ports 1010 are sealed; that is to say, gases from the annulus region 180 are not able to pass through the fill ports 1010 because the fill ports 1010 are capped with suitable sealed plugs. In an alternative step to step S605 in FIG. 6, a probe may be used to pierce the purge outlet 340 and thus measure the annulus pressure. In other words, the probe may be used to make a hole in the purge outlet 340. In some examples, the probe is connected to the tube 360 of the adapter 410. Therefore, annulus gases are able to pass from the annulus region of flexible pipe body 100 to the module 350. In other words, the purge outlet 340 may provide a fluid communication with the module 350.

FIG. 11 illustrates an alternative version of the end fitting 320. In FIG. 11, the purge outlet 340 in the end fitting 320 is in a front-end venting system configuration 1110. Annulus gases from the annulus region 180 pass through the purge outlet 340 in a vent tubing 1120 to the module 350. The vent tubing 1120 is a stainless-steel tubing which connects the annulus region 180 to the purge outlet 340. The vent tubing 1120 is surrounded by hardened epoxy in the epoxy housing 1060. It will be appreciated that the vent tubing 1120 may alternatively be made from any alloy, composite, polymer, or the like.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of retrieving an underwater flexible pipe, comprising:
urging an end region of a flexible pipe towards a floating platform at a flexible pipe retrieval velocity thereby lifting the flexible pipe through water;
as the flexible pipe is lifted, determining a relationship between an annulus pressure in an annulus region of the flexible pipe and a local water pressure proximate to at least one purge outlet on an end fitting of the flexible pipe; and
responsive to the relationship, selecting the flexible pipe retrieval velocity.

2. The method as claimed in claim 1, further comprising:
said step of selecting the retrieval velocity comprises repeatedly determining a maximum advisable retrieval velocity; and
setting the flexible pipe retrieval velocity at or within 1 Om/hour below the maximum advisable retrieval velocity.

3. The method as claimed in claim 1, further comprising:
selecting the flexible pipe retrieval velocity according to:
$$AP < WP + SM$$
where AP is annulus pressure proximate to the purge outlet, WP is local water pressure proximate to the purge outlet, and SM is a predetermined safety margin.

4. The method as claimed in claim 3, wherein the predetermined safety margin is at least 2 bar and optionally is at least 3 bar.

5. The method as claimed in claim 3, further comprising:
as the flexible pipe is lifted, repeatedly measuring annulus pressure (AP) proximate to the purge outlet and repeatedly determining local water pressure (WP) proximate to the purge outlet; and
determining a rate of change of annulus pressure and a rate of change of water pressure responsive thereto.

6. The method as claimed in claim 1, further comprising:
securing a module, comprising a housing that contains an annulus pressure sensor and a local water pressure sensor, to the end fitting; and
securing a respective fluid communication passageway in fluid communication with the annulus pressure sensor between the housing and the purge outlet.

7. The method as claimed in claim 6, further comprising:
communicating local water pressure to the local water pressure sensor via a water pressure port in the housing and a respective further fluid communication passageway between the water pressure port and the local water pressure sensor; and
communicating annulus pressure to the annulus pressure sensor via the first fluid communication passageway.

8. The method as claimed in claim 6, further comprising:
wirelessly communicating an annulus pressure value and a local environmental water pressure value from the module.

9. The method as claimed in claim 1, further comprising:
securing a first fluid communication passageway, in fluid communication with an annulus pressure sensor on a remotely operated vehicle (ROV) that further comprises a local water pressure sensor, to the purge outlet.

10. The method as claimed in claim 8, further comprising:
wirelessly communicating by transmitting an ultrasound signal from an ultrasound modem in the module or by transmitting light from one or more light emitting elements on the housing or by wirelessly transmitting a wireless signal from an ROV proximate to the module.

11. Apparatus for providing data during a flexible pipe retrieval process for an underwater flexible pipe, comprising:
an annulus connection member comprising a housing connectible to a purge outlet of an end fitting of a flexible pipe; and
a fluid communication passageway having a first end that is connected to and is in fluid communication with the annulus connection member and a further end connected to and in fluid communication with an annulus pressure sensor in a waterproof housing.

12. The apparatus as claimed in claim 11, further comprising:
the annulus connection member comprises a rigid body that has a first body end region that includes a purge valve and purge orifice and a further body end region that comprises a securing element for securing to an aperture of the purge outlet.

13. The apparatus as claimed in claim 11 further comprising:
a module comprising the waterproof housing and the annular pressure sensor and further comprising a water pressure port comprising an opening in the housing and the fluid communication passageway extending between the opening and a water pressure sensor in the housing.

14. The apparatus as claimed in claim 13, further comprising:
a wireless modem comprising a transmitter element for transmitting an annulus pressure value and a local water pressure value.

15. The apparatus as claimed in claim 13, further comprising:
a storage medium for recording a plurality of an annulus pressure value, a local water pressure value, and a time value associated with the annulus pressure value and the local water pressure value.

16. The apparatus as claimed in claim 11, further comprising:
a remotely operated vehicle (ROV) comprising the waterproof housing and the annulus pressure sensor and further comprising a water pressure port comprising a through opening in an outer wall of the ROV and a fluid communication passageway extending between the opening and a water pressure sensor in the housing of the ROV.

17. The apparatus as claimed in claim 16, further comprising:
a wireless modem comprising a transmitter element for transmitting an annulus pressure value and a local water pressure value.

18. The apparatus as claimed in claim 16, further comprising:
the securing element comprises a piercing element for securing to the aperture of the purge outlet.

19. A method of retrieving a subsea pipeline, comprising:
one-by-one, urging an end of a flexible pipe, of each of a plurality of flexible pipes of a pipeline that comprises a plurality of flexible pipes disposed in an end-to-end configuration, towards a surface platform thereby lifting the pipeline through the water; and
varying a flexible pipe retrieval velocity responsive to an annulus pressure in an annulus region of a current uppermost flexible pipe of the pipeline as the flexible pipes of the pipeline are lifted, to maintain at least a predetermined average flexible pipe retrieval velocity for the pipeline.

20. The method as claimed in claim 19, further comprising:
varying the flexible pipe retrieval velocity also responsive to a local water pressure proximate to the current uppermost flexible pipe of the pipeline.
